(19) United States
(12) Patent Application Publication
(10) Pub. No.: US 2019/0232342 A1
(43) Pub. Date: Aug. 1, 2019

(54) DEVICE AND METHOD FOR CLEANING A WORKPIECE

(71) Applicant: Ecoclean GmbH, Filderstadt (DE)

(72) Inventor: Egon KÄSKE, Aachen (DE)

(21) Appl. No.: 16/382,000

(22) Filed: Apr. 11, 2019

Related U.S. Application Data
(63) Continuation of application No. PCT/EP2017/075848, filed on Oct. 10, 2017.

(30) Foreign Application Priority Data
Oct. 12, 2016 (DE) 10 2016 119 436.0

(51) Int. Cl. B08B 5/04; B08B 3/04; B08B 9/00

(52) U.S. Cl. CPC B08B 5/04; B23Q 11/0075; B08B 9/00; B08B 3/04

(57) ABSTRACT

In order to provide a device for cleaning a workpiece, which includes an arrangement for generating a negative pressure as a result of which a cleaning fluid is drawable out of a cavity in the workpiece by suction, wherein the device is of simple construction and/or is easy to control, it is proposed that the arrangement for generating the negative pressure should include an injector.

### RELATED APPLICATIONS

This application is a continuation application of International Patent Application No. PCT/EP2017/075848, filed on Oct. 10, 2017, which claims priority to German Patent Application No. 10 2016 119 436, filed on Oct. 12, 2016. The foregoing International Patent Application and the German Patent Application are hereby incorporated by reference.

### FIELD OF DISCLOSURE

The present invention relates to a device for cleaning a workpiece, which includes an arrangement for generating a negative pressure as a result of which a cleaning fluid is drawable out of a cavity in the workpiece by suction.

### BACKGROUND

A device of this kind is known from EP 2 246 128 A2.

In this known device, a workpiece that is to be cleaned is immersed in a vessel of cleaning liquid, and an opening in a cavity provided in the workpiece is placed on an adapter that is connected to a vacuum chamber by way of a suction line provided with a valve. Another opening in the cavity in the workpiece is open and is covered by the cleaning liquid. Once the vacuum chamber has been evacuated, the valve in the suction line is opened, as a result of which the cleaning liquid is drawn through the cavity in the workpiece and into the vacuum chamber.

In this known device for cleaning a workpiece, it is disadvantageous that a vacuum chamber and a vacuum pump for evacuating the vacuum chamber are required, as a result of which a large expense arises for the vacuum technology and for the control equipment for the vacuum technology.

### SUMMARY OF THE INVENTION

It is the object of the present invention to provide a device for cleaning a workpiece of the type mentioned in the introduction that is of simple construction and/or is easy to control.

This object is achieved according to the invention by a device for cleaning a workpiece, including an arrangement for generating a negative pressure as a result of which a cleaning fluid is drawable out of a cavity in the workpiece by suction, wherein the arrangement for generating the negative pressure includes an injector.

In an injector of this kind, a negative pressure is generated by generating a jet of an injection fluid by the jet pump or Venturi principle.

An injector system of this kind that includes an injector is of very simple construction and is functionally reliable. The pressurised injection fluid may be provided by a washing pump, which is conventionally present in any case in a cleaning device.

In a preferred embodiment of the invention, it is provided for the device to include an adapter for making a fluid connection between a discharge opening of a cavity in the workpiece and the injector.

An adapter of this kind may take a rigid form or a flexible form, in particular a resiliently yielding form, for the purpose of compensating for position tolerances of the workpiece and/or the injector.

The adapter may include a seal for providing fluid-tight sealing between the discharge opening of the cavity and the area outside the workpiece.

The workpiece may include a plurality of cavities that are not in fluid connection with one another and have different discharge openings. In this case, it is advantageous if, for each such discharge opening, the device includes a respectively associated adapter for making a fluid connection between the relevant discharge opening and an injector. In this case, the different discharge openings may be connected to the same injector or to different injectors.

The device may include a suction system that includes the injector and at least two adapters for making a fluid connection between, in each case, one discharge opening of a cavity in the workpiece and the injector.

During the cleaning procedure, a suction system of this kind may in particular be arranged laterally alongside the workpiece.

The injector may include an injection nozzle for introducing an injection fluid into an interior of the injector.

The interior of the injector may have a constriction downstream of the injection nozzle.

The injection fluid may be different from the cleaning fluid or identical to the cleaning fluid.

Preferably, the injection fluid is an injection liquid.

As the injection fluid there may be used for example water, a detergent solution (with or without microbubbles), a cleaning agent containing solvent, an acid, a cooling lubricant and/or an oil.

The cleaning fluid may be a cleaning liquid or a gaseous cleaning medium such as air.

As the cleaning fluid there may be used for example water, a detergent solution (with or without microbubbles), a cleaning agent containing solvent, an acid, a cooling lubricant and/or an oil.

At least one auxiliary agent having a cleaning action may be added to the cleaning fluid.

An auxiliary agent of this kind may be for example a solid, in particular in the form of granules, a salt and/or in the form of ice pellets.

Further, an auxiliary agent of this kind may include microbubbles in a liquid medium.

The temperature of the cleaning fluid is preferably adapted to the type of dirt affecting the workpiece, and to the requirements made of cleanliness of the workpiece after cleaning.

In particular, it may be provided for the temperature of the cleaning fluid to lie above a conventional room temperature, in particular above 30° C., particularly preferably above 50° C.

The workpiece to be cleaned may be made from any desired material, for example a metal material, a ceramic material and/or a synthetic material.

The workpiece to be cleaned may in particular be a machined workpiece in the cavity whereof there are machining residues, in particular solid particles such as swarf.

In a particular embodiment of the device according to the invention, it is provided for the device to include an outlet closing device downstream of the injector and is preferably closable in a cyclic manner, for the purpose of closing off a flow path of a fluid discharged from the injector. By closing the outlet closing device, it is possible to reverse the direction of flow of the cleaning fluid in the cavity in the workpiece and thus cause an alternating flow through the cavity. Reversing the direction of flow of the cleaning fluid in the cavity in the workpiece considerably improves the cleaning action. When flow is reversed, dirt that has clogged or been deposited at narrow points or undercuts in the cavity is loosened and transported away with the cleaning fluid.

Further, the device according to the invention preferably includes an injection closing device upstream of the injector, for the purpose of closing off a flow path of an injection fluid to be supplied to the injector. By opening an injection closing device of this kind, it is possible to activate the injector system in a simple manner for the purpose of generating a negative pressure, and by closing an injection closing device of this kind it is possible to deactivate the injector system in a simple manner.

Further, in a particular embodiment of the invention it may be provided for the device to include a modulation device upstream of the injector, for the purpose of generating a modulated injection fluid flow to the injector.

Using a modulation device of this kind, preferably a pulsed injection fluid flow is configured to be generated through the injector, and this results in generation of a pulsed negative pressure at the discharge opening of the cavity in the workpiece.

A pulsed negative pressure of this kind also makes it possible to reverse the flow of the cleaning fluid in the cavity in the workpiece, as a result of which an improvement in the cleaning action is achieved.

A modulation device of this kind may include for example a pulse valve having a rotating valve element, as described in particular in WO 03/036144 A1.

The outlet closing device and/or the injection closing device may in particular take the form of a switching valve.

The device according to the invention preferably includes a control device that controls in particular the outlet closing device, the injection closing device, the modulation device and/or the injection fluid pump of the device, where the said elements are present in the respective device, and where appropriate also further controllable elements of the device.

Further, it may be provided for the device to include at least two injectors that are configured to be brought—preferably alternating with one another—into fluid connection with a respective discharge opening of a cavity, preferably the same cavity, in the workpiece. In this way too, it is possible to reverse the direction of flow of the cleaning fluid in the cavity in the workpiece in a manner that improves the cleaning action of the device.

Preferably here, it is provided for the device to include a manipulator by means of which the workpiece and/or at least one injector is movable from a separated position in which the workpiece and the respective injector are separated from one another into a connected position in which a cavity in the workpiece and the respective injector are in fluid connection with one another.

The manipulator preferably takes the form of a freely programmable handling device with its own drive, for example an electrical, hydraulic or pneumatic drive.

In particular, it may be provided for the manipulator to include an industrial robot.

The device according to the invention may further include at least one jet nozzle that is configured to generate a jet of a jet fluid that is directed towards an access opening to a cavity in the workpiece.

By means of a jet of jet fluid of this kind, the cleaning action of the device is improved, in particular in the regions of the cavity in the workpiece that are adjacent to the access opening acted upon by the jet.

The jet fluid may be identical to the cleaning fluid or indeed different therefrom.

In particular, the jet fluid may include a jet liquid.

As an alternative or in addition thereto, it may also be provided for the jet fluid to include a gaseous jet medium, for example compressed air.

In a preferred embodiment of the invention, it is further provided for the device to include a cleaning fluid vessel in which the workpiece is configured to be arranged such that an access opening to a cavity in the workpiece is immersed in a volume of cleaning fluid that is in the cleaning vessel.

Another subject matter of the invention is a combination of a device according to the invention for cleaning a workpiece and a workpiece to be cleaned using the device.

The present invention further relates to a method for cleaning a workpiece that includes a cavity having an access opening and a discharge opening.

It is a further object of the present invention to provide a method of this kind that is performable simply and at little expense but still enables thorough cleaning of the workpiece.

This object is achieved by a method for cleaning a workpiece that includes a cavity having an access opening and a discharge opening, said method including the following:
arranging the workpiece such that the access opening is immersed in a volume of cleaning fluid; and
generating a negative pressure by means of which cleaning fluid is drawn out of the workpiece by suction through the discharge opening of the cavity, using an injector.

Here, it is particularly favourable for achieving a good cleaning action if a direction of flow of the cleaning fluid in the cavity in the workpiece is at least temporarily reversed in at least one region of the cavity. Reversing the flow makes it possible in particular to loosen jammed solid particles, for example swarf, better and to transport them away with the cleaning fluid.

Particular embodiments of the method according to the invention have already been explained above in conjunction with particular embodiments of the device according to the invention for cleaning a workpiece.

The method according to the invention may be performed in particular using the device according to the invention for cleaning a workpiece. The device according to the invention for cleaning a workpiece is suitable in particular for performing the method according to the invention for cleaning a workpiece.

The device according to the invention for cleaning a workpiece is suitable in particular for use as a pre-cleaning system upstream of a water-based cleaning installation.

By means of the device according to the invention, preferably solid particles, in particular machining residues such as swarf, blasting agents, casting sand and similar, and machining residues in liquid and/or paste form such as oils, cooling lubricant and/or greases, are removed from the workpiece to be cleaned.

As a result, in particular the bath lifetime in the downstream cleaning installation can be made longer.

Further, the device according to the invention for cleaning a workpiece may be used as a final cleaning device or as an intermediate cleaning device upstream of an assembly line.

The device according to the invention may in particular serve to remove dirt that has arisen as a result of storing and/or transporting the workpiece.

Any cleaning installation in which there is a cleaning vessel that is filled or to be filled and a washing pump can easily be converted into a device according to the invention for cleaning a workpiece.

Further features and advantages of the invention form the subject matter of the description below and the representation in the drawings of exemplary embodiments.

### BRIEF DESCRIPTION OF THE DRAWINGS

FIG. 1 shows a schematic illustration of a first embodiment of a device for cleaning a workpiece in a bath of cleaning fluid, wherein the workpiece is connected to an injector for the purpose of generating a negative pressure in a cavity in the workpiece;

FIG. 2 shows an enlarged schematic illustration of the injector of the device from FIG. 1;

FIG. 3 shows a schematic illustration of a second embodiment of a device for cleaning a workpiece, which includes an outlet closing device downstream of the injector, for the purpose of closing off a flow path of a fluid discharged from the injector;

FIG. 4 shows a schematic illustration of a third embodiment of the device for cleaning a workpiece, which includes a modulation device upstream of the injector, for the purpose of cyclically closing off a flow path of an injection fluid to be supplied to the injector;

FIG. 5 shows a schematic illustration of a fourth embodiment of a device for cleaning a workpiece, which includes a suction system that is configured to make a fluid connection between a plurality of discharge openings of a cavity in the workpiece and the injector;

FIG. 6 shows a schematic illustration of a fifth embodiment of a device for cleaning a workpiece, which includes a plurality of injectors to which the workpiece is alternately connectable in order to generate a negative pressure in a cavity in the workpiece, wherein a cavity in the workpiece is in fluid connection with a first injector; and

FIG. 7 shows a schematic illustration, corresponding to FIG. 6, of the fifth embodiment of the device for cleaning a workpiece, wherein the workpiece has been moved in relation to the injectors and the cavity in the workpiece is in fluid connection with a second injector.

Like or functionally equivalent elements are designated by the same reference numerals in all the Figures.

### DETAILED DESCRIPTION OF THE INVENTION

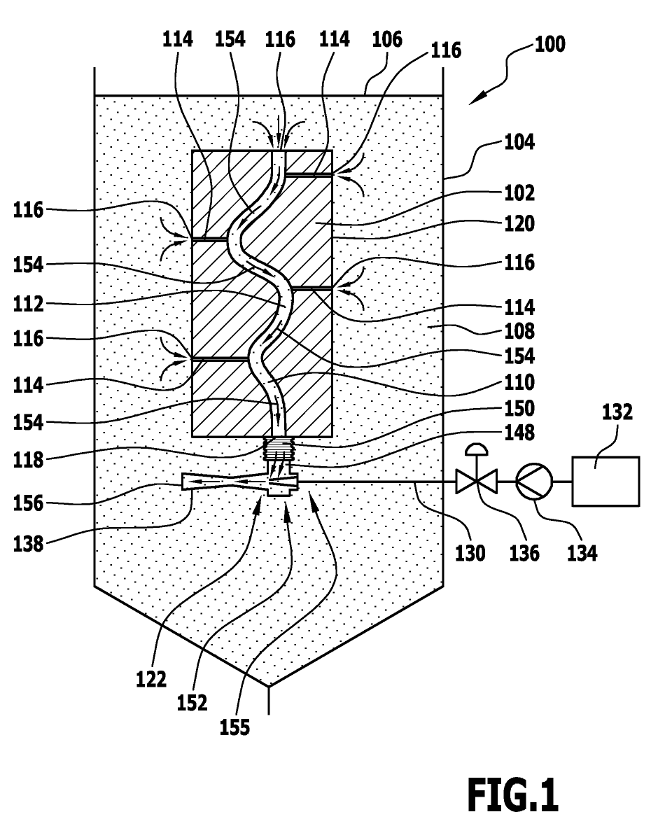

A device, illustrated in FIG. 1 and designated 100 as a whole, for cleaning a workpiece 102 includes a cleaning vessel 104 that is fillable up to a level 106 with a volume 108 of cleaning fluid, in particular of cleaning liquid.

As the cleaning fluid there may be used for example water, a detergent solution (with or without microbubbles), a cleaning agent containing solvent, an acid, a cooling lubricant and/or an oil.

As an alternative or in addition thereto, a gaseous cleaning fluid such as air may be used as the cleaning fluid.

The temperature of the cleaning fluid is preferably adapted to the type of dirt affecting the workpiece 102, and to the requirements made of cleanliness of the workpiece 102 after cleaning thereof.

In particular, it may be provided for the temperature of the cleaning fluid to lie above a conventional room temperature, in particular above 30° C., particularly preferably above 50° C.

The workpiece 102 to be cleaned is introduced into the volume 108 of cleaning fluid in order to perform a cleaning procedure.

The workpiece 102 has one or more cavities 110, wherein each cavity 110 may include a main channel 112 through which the cleaning fluid is configured to flow and one or more secondary channels 114 through which the cleaning fluid is configured to flow, and which are in fluid connection with the main channel 112.

The cavity 110 in the workpiece 102 has at least one access opening 116 through which cleaning fluid can pass into the cavity 110, and at least one discharge opening 118, different from the access opening 116, through which cleaning fluid is drawable out of the cavity 110 by suction.

The access opening 116 and/or the discharge opening 118 are preferably arranged on an outer surface 120 of the workpiece 102.

The access openings 116 may lead directly to the main channel 112 or to a secondary channel 114 of the cavity 110.

The discharge opening 118 may be provided on the main channel 112 or a secondary channel 114.

The workpiece 102 may be made from any desired material, for example a metal material, a ceramic material and/or a synthetic material.

The device 100 further includes an injector 122 for generating a negative pressure, by means of which the cleaning fluid is configured to be drawn out of the cavity 110 in the workpiece 102 by suction.

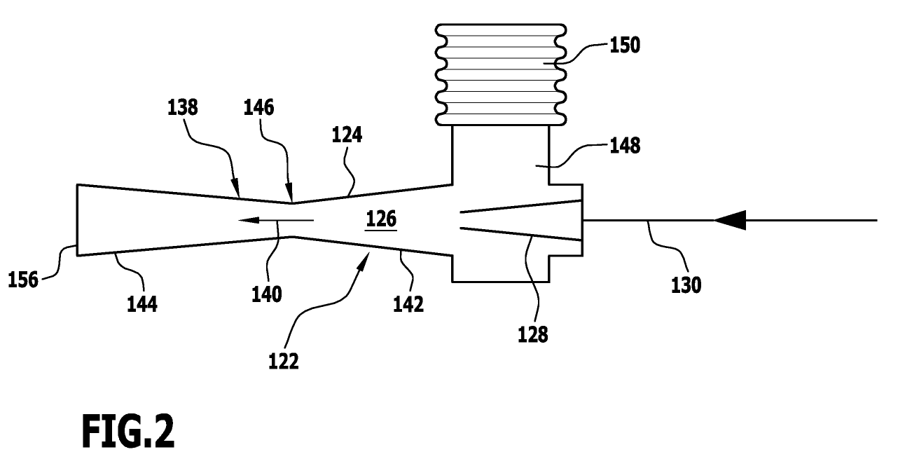

As can best be seen from the enlarged illustration in FIG. 2, the injector 122 includes a housing 124 into the interior 126 whereof there opens an injection nozzle 128.

By way of an injection fluid line 130, the injection nozzle 128 is connected to an injection fluid reservoir 132 (illustrated in FIG. 1).

Arranged in the injection fluid line 130 are an injection fluid pump 134 and an injection closing device 136 for the purpose of closing off the flow path of an injection fluid to be supplied to the injector 122.

The injection closing device 136 may take the form for example of a switching valve.

The injection closing device 136 is preferably arranged downstream of the injection fluid pump 134 and upstream of the injection nozzle 128.

The device 100 includes a control device (not illustrated) that controls in particular the injection fluid pump 134 and the injection closing device 136.

Further, the injector 122 includes an outlet 138 that includes an entry region 142, which tapers in the direction of flow 140 of the fluid through the outlet 138, and an exit region 144, which comes after the entry region 142 as seen in the direction of flow 140.

The entry region 142 and the exit region 144 are adjacent to one another at a constriction 146 in the interior 126 of the injector 122.

At the constriction 146, which forms a narrow point in the flow path of the fluid through the injector 122, the cross section of the interior 126 of the injector 122 perpendicular to the direction of flow 140 is minimal.

Further, the injector 122 includes an aspiration line 148 through which cleaning fluid that is drawn out of the cavity 110 in the workpiece 102 by suction is feedable into the entry region 142 of the injector 122.

The aspiration line 148 may be provided with an adapter 150 that, during operation of the device 100, is configured to be brought into contact with a region of the outer surface 120 of the workpiece 102 surrounding the discharge opening 118 of the cavity 110 in the workpiece 102, such that the injector 122 abuts against the workpiece 102 in a fluid-tight manner by way of the adapter 150, and the interior of the aspiration line 148 is separated in a fluid-tight manner from the volume 108 of cleaning fluid surrounding the injector 122.

The device 100 may further include a manipulator (not illustrated) by means of which the workpiece 102 and/or the injector 122 is movable from a separated position in which the workpiece 102 and the injector 122 are separated from one another into a connected position in which the cavity 110 in the workpiece 102 and the injector 122 are in fluid connection with one another.

Using the above-described device 100 for cleaning the workpiece 102, a method for cleaning the workpiece 102 is performed as follows:

The cleaning vessel 104 is filled entirely or partially with a volume 108 of the cleaning fluid.

The workpiece 102 to be cleaned is set down in the entirely or partially filled cleaning vessel 104 on a workpiece receptacle (not illustrated) or is held in a predetermined cleaning position by a manipulator (not illustrated).

Here, the workpiece 102 is arranged in relation to the injector 122 such that a discharge opening 118 of the cavity 110 in the workpiece 102 is in fluid connection with the aspiration line 148 of the injector 122, and is sealed off from the area around the workpiece 102 by the adapter 150 of the injector 122.

The adapter 150 may take a rigid form or a flexible form, preferably a resiliently yielding form, in particular in the manner of a bellows, in order to be able to compensate for tolerances in positioning the workpiece 102 in relation to the injector 122.

The workpiece 102 is arranged such that at least one access opening 116, different from the discharge opening 118, in the cavity 110 is immersed in the volume 108 of cleaning fluid that is in the cleaning vessel 104.

This at least one access opening 116 to the cavity 110 is open, with the result that cleaning fluid can penetrate into the cavity 110 through this access opening 116.

Once the workpiece 102 has been docked onto the injector 122, the injector system 152, which includes the injector 122, the injection fluid pump 134 and the injection closing device 136, is activated in that the flow path of the injection fluid is opened by the injection closing device 136, with the result that the injection fluid, which is conveyed out of the injection fluid reservoir 132 by the (preferably continuously operating) injection fluid pump 134, passes through the injection nozzle 128 and into the interior 126 of the injector 122 and forms an injection fluid jet there.

The pressure of the injection fluid at the exit opening of the injection nozzle 128 is preferably at least 1 bar.

Further, the positive pressure of the injection fluid at the exit opening of the injection nozzle 128 is preferably at most approximately 350 bar, in particular at most approximately 15 bar, particularly preferably at most approximately 3.5 bar.

The injection fluid may be different from the cleaning fluid or identical to the cleaning fluid.

The injection fluid is preferably an injection liquid.

As the injection fluid there may be used for example water, a detergent solution (with or without microbubbles), a cleaning agent containing solvent, an acid, a cooling lubricant and/or an oil.

If the injection fluid is identical to the cleaning fluid, the injection fluid pump 134 may be attached at the suction side of the volume 108 of cleaning fluid in the cleaning vessel 104; in that case, it is not necessary to provide a separate injection fluid reservoir 132 for the injection fluid.

Activating the injector system 152 generates a suction flow by the jet pump or Venturi principle, and this suction flow gives rise, in the aspiration line 148 of the injector 122, to a negative pressure by means of which cleaning fluid that has penetrated into the cavity 110 in the workpiece 102 is conveyed through the discharge opening 118 and into the injector 122.

Thus, the injector system 152 serves as an arrangement 155 for generating a negative pressure.

Cleaning fluid flows through the access openings 116 to the cavity 110 in the workpiece 102, which are in fluid connection with the volume 108 of cleaning fluid, and thus tops up the cavity 110, with the result that a flow of cleaning fluid through the cavity 110 in the workpiece 102 is generated, the direction of flow thereof being illustrated in FIG. 1 by the arrows 154. Foreign bodies such as solid particles, in particular swarf, in the cavity 110 in the workpiece 102 are entrained by the flow of cleaning fluid and conveyed to the exit opening 156 of the injector and from there carried out of the injector 122.

At least one auxiliary agent having a cleaning action may be added to the cleaning fluid.

An auxiliary agent of this kind may be for example a solid, in particular in the form of granules, a salt and/or in the form of ice pellets.

Further, an auxiliary agent of this kind may include microbubbles in a liquid medium.

Once the cleaning procedure has concluded, the injector system 152 is deactivated by closing the injection closing device 136, and the workpiece 102 is released from its docked position on the injector 122 and removed from the cleaning vessel 104.

If the ambient air is used as the cleaning fluid, it is possible to dispense with the cleaning vessel 104; the ambient air serving as the cleaning fluid can then top up the cavity 110 in the workpiece 102 from the atmosphere surrounding the workpiece 102 when the injector system 152 is activated.

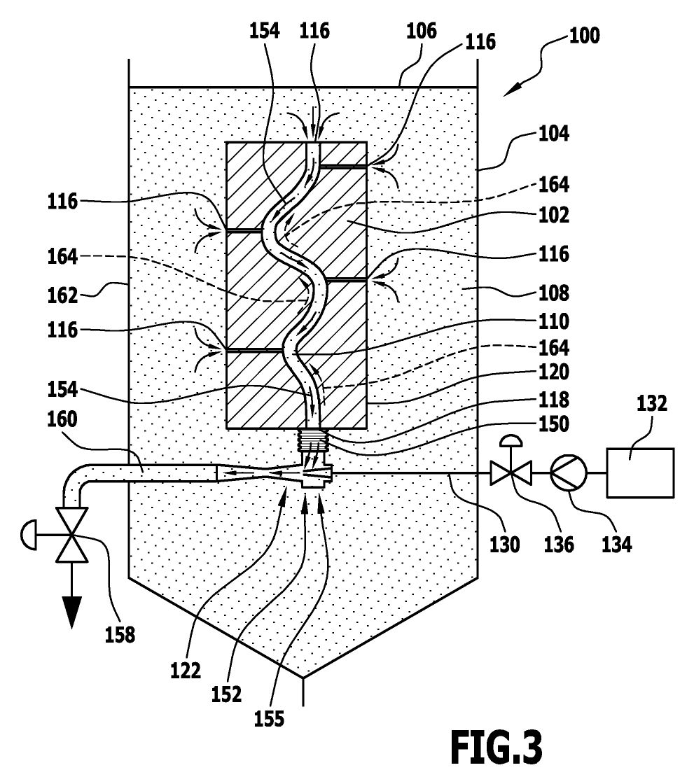

A second embodiment, illustrated in FIG. 3, of a device 100 for cleaning a workpiece 102 differs from the embodiment illustrated in FIG. 1 in that the device 100 includes an outlet closing device 158 downstream of the injector 122, for the purpose of closing off the flow path of the fluid discharged from the injector 122.

The fluid discharged from the injector 122 includes the injection fluid and the cleaning fluid.

The outlet closing device 158 may in particular include a switching valve that is controllable by the control device of the device 100.

The outlet closing device 158 is connected to the outlet 138 of the injector 122 by way of an outlet line 160.

The outlet line 160 may be guided through a wall 162 of the cleaning vessel 104, with the result that the outlet closing device 158 may be arranged outside the cleaning vessel 104.

The fluid that flows through the outlet closing device 158 when the outlet closing device 158 is open is preferably collected in a collecting vessel (not illustrated) and disposed of or—where appropriate after reprocessing, in particular filtration—supplied to the cleaning vessel 104 again.

During the cleaning procedure, the outlet closing device 158 is only opened temporarily, preferably in a cyclic manner, and then closed again. During the closed phases of the outlet closing device 158, a change in the direction of flow of the cleaning fluid through the cavity 110 in the workpiece 102 is produced.

This reversal of the direction of flow of the cleaning fluid in the cavity 110 is illustrated in FIG. 3 by the dashed arrows 164.

Changing the direction of flow of the cleaning fluid in the cavity 110 in the workpiece 102 means that the cavity 110 is flushed through in an alternating manner by the cleaning fluid, as a result of which jammed dirt can be loosened more easily.

This improves the cleaning action in the workpiece 102 considerably.

When flow is reversed in this way, dirt that has clogged or been deposited at narrow points or undercuts in the cavity 110 in the workpiece 102 is loosened and transported away with the cleaning fluid.

Otherwise, the second embodiment of the device 100 for cleaning the workpiece 102 that is illustrated in FIG. 3 corresponds, as regards its structure, functioning and manufacture, to the first embodiment illustrated in FIGS. 1 and 2, so in this respect reference is made to the description thereof above.

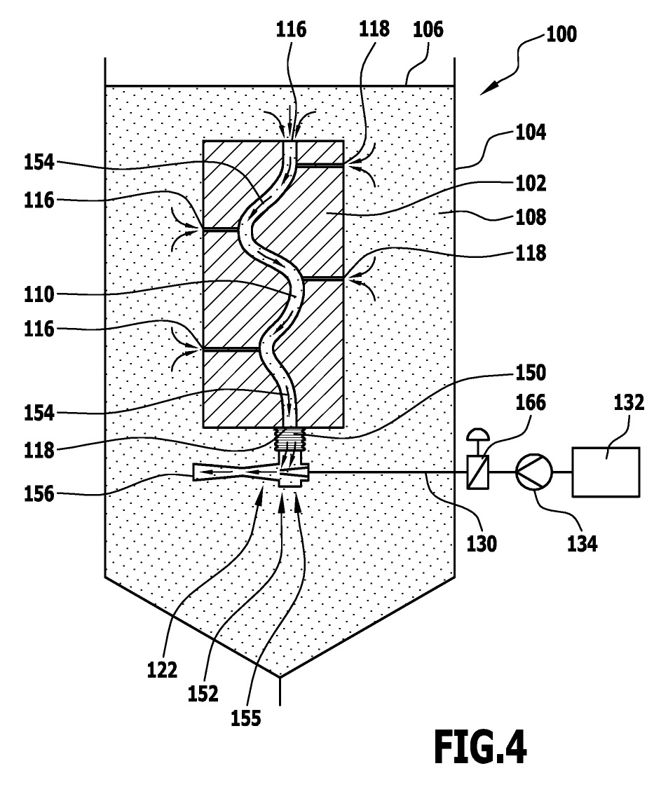

A third embodiment, illustrated in FIG. 4, of a device 100 for cleaning a workpiece 102 differs from the first embodiment illustrated in FIGS. 1 and 2 in that, as an alternative or in addition to the injection closing device 136, the device 100 includes a modulation device 166, arranged in the injection fluid line 130 upstream of the injector 122, for the purpose of generating a modulated injection fluid flow to the injector 122.

Using the modulation device 166, a pulsed injection fluid flow is configured to be generated through the injector 122, and this results in generation of a pulsed negative pressure at the discharge opening 118 of the cavity 110 in the workpiece 102.

A pulsed negative pressure of this kind also makes it possible to reverse the flow of the cleaning fluid in the cavity 110 in the workpiece 102, as a result of which an improvement in the cleaning action is achieved, as described above in conjunction with the second embodiment of the device 100, illustrated in FIG. 3.

The modulation device 166 may include for example a pulse valve having a rotating valve element, as described in WO 03/036144 A1, to which reference is made in respect of the structure and functioning of a pulse valve of this kind.

Otherwise, the third embodiment of the device 100 for cleaning the workpiece 102 that is illustrated in FIG. 4 corresponds, as regards its structure, functioning and manufacture, to the first embodiment illustrated in FIGS. 1 and 2, so in this respect reference is made to the description thereof above.

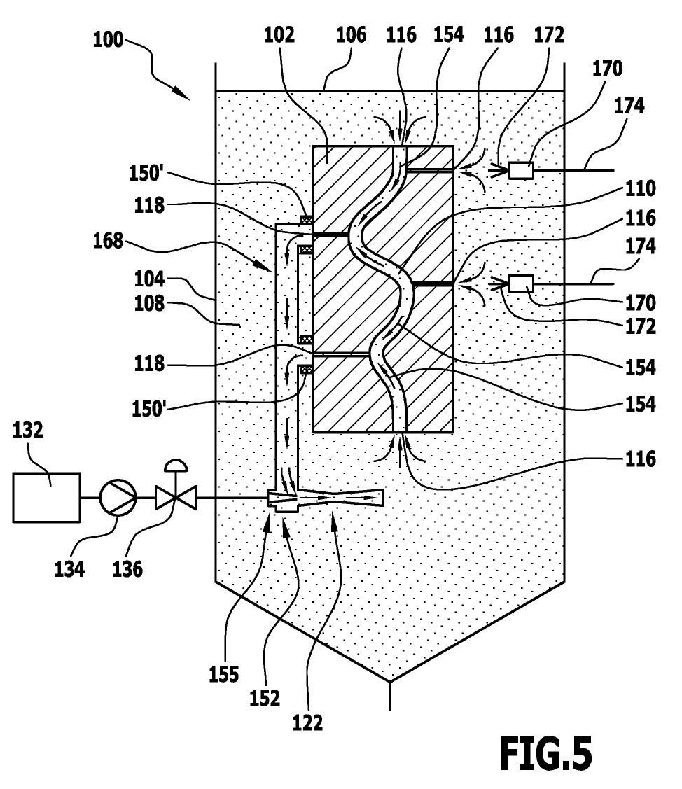

A fourth embodiment, illustrated in FIG. 5, of a device 100 for cleaning a workpiece 102 differs from the first embodiment illustrated in FIGS. 1 and 2 in that the injector 122 is in fluid connection not only with a single discharge opening 118 of the cavity 110 in the workpiece 102 but with two or more discharge openings 118 of the cavity 110.

For this purpose, the device 100 includes a suction system 168 that includes the injector 122 and at least two adapters 150′ for making a fluid connection between, in each case, one discharge opening 118 of the cavity 110 in the workpiece 102 and the injector 122.

Here, the discharge opening 118 may in particular be arranged on a side wall of the workpiece 102 to be cleaned.

In this case, the local direction of flow 154 of the cleaning fluid in the cavity 110 is directed towards the respectively closest discharge opening 118.

Further, taking as an example the fourth embodiment, FIG. 5 illustrates the fact that the device 100 may include one or more jet nozzles 170 by means of which a respective jet 172 of a jet fluid, directed towards an access opening 116 to the cavity 110 in the workpiece 102, is configured to be generated.

The jet fluid is supplied to the respective jet nozzle 170 by way of a respective jet fluid line 174.

The jet fluid lines 174 may be fed from a jet fluid reservoir (not illustrated) for example by way of a jet fluid pump.

The jet fluid may be identical to the cleaning fluid or indeed different therefrom. In particular, the jet fluid may include a jet liquid.

In this case, the jet nozzle 170 preferably takes the form of a spray nozzle.

As an alternative or in addition thereto, it may also be provided for the jet fluid to include a gaseous jet medium, for example compressed air.

In this case, the jet nozzle 170 preferably takes the form of a compressed air nozzle.

As a result of the jets 172 of jet fluid that are generated by means of the jet nozzles 170, the cleaning action of the device 100 is improved, in particular in the regions of the cavity 110 in the workpiece 102 adjoining the access openings 116 that are acted upon by the jets 172.

Otherwise, the fourth embodiment of the device 100 for cleaning the workpiece 102 that is illustrated in FIG. 5 corresponds, as regards its structure, functioning and manufacture, to the first embodiment illustrated in FIGS. 1 and 2, so in this respect reference is made to the description thereof above.

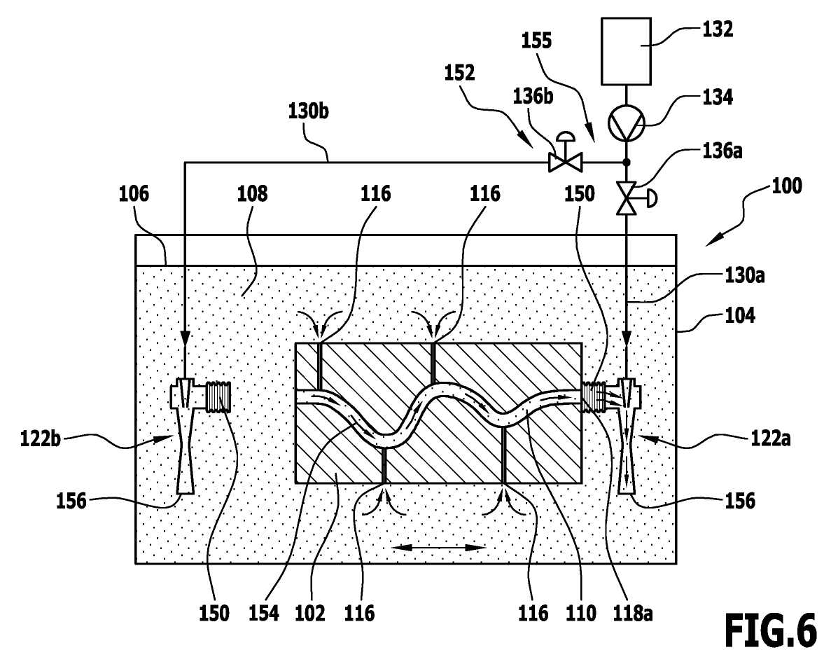

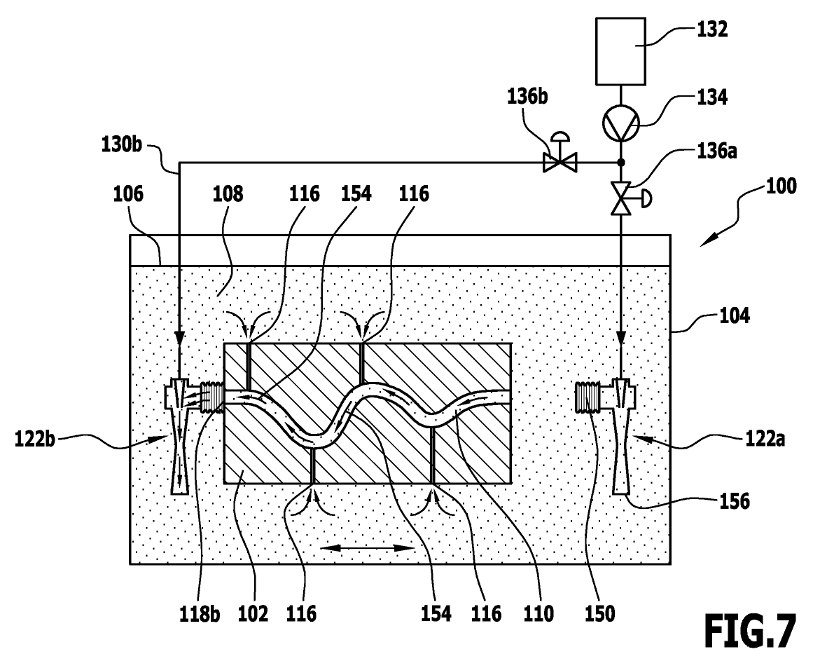

A fifth embodiment, illustrated in FIGS. 6 and 7, of a device 100 for cleaning a workpiece 102 differs from the first embodiment illustrated in FIGS. 1 and 2 in that the device 100 includes two or more injectors 122, which are configured to be brought alternately into fluid connection with a respective discharge opening 118 of the cavity 110 in the workpiece 102.

In this way too, it is possible to achieve a reversal of the direction of flow of the cleaning fluid in the cavity 110 in the workpiece 102 in a manner that improves the cleaning action of the device 100.

In a first cleaning position, illustrated in FIG. 6, the workpiece 102 is in contact with a first injector 122a, which is connected by way of a first injection fluid line 130a and a first injection closing device 136a to an injection fluid pump 134 that conveys injection fluid out of an injection fluid reservoir 132.

When the injection closing device 136a is open, cleaning fluid is drawn out of the cavity 110 in the workpiece 102 by suction, through a first discharge opening 118a and into the first injector 122a.

After a first cleaning phase, the first injection closing device 136a is closed.

The workpiece 102 is moved away from the first injector 122a—for example by means of a manipulator (not illustrated)—towards a second injector 122b and brought into contact therewith, with the result that the cavity 110 in the workpiece 102 is now in fluid connection with the second injector 122b.

The second injector 122b is connected by way of a second injection fluid line 130b and a second injection closing device 136b to the outlet on the pressure side of the injection fluid pump 134.

By opening the second injection closing device 136b, a second cleaning phase is initiated, during which cleaning fluid is drawn out of the cavity 110 in the workpiece 102 by suction, through a second discharge opening 118b in the cavity 110 and into the second injector 122b.

Since the second discharge opening 118b is arranged at an end region of the workpiece 102 on the opposite side to the first discharge opening 118a, during the second cleaning phase the cleaning fluid in the cavity 110 moves in the opposite direction of flow 154 to the direction of flow 154 of the cleaning fluid in the cavity 110 during the first cleaning phase.

In this embodiment of the device 100 for cleaning the workpiece 102, too, a reversal of the flow of the cleaning fluid in the cavity 110 in the workpiece 102 and thus an improved cleaning action are hence achieved during the cleaning procedure.

At the end of the second cleaning phase, the second injection closing device 136b is closed and the cleaned workpiece 102 is removed from the cleaning vessel 104.

Otherwise, the fifth embodiment of the device 100 for cleaning the workpiece 102 that is illustrated in FIGS. 6 and 7 corresponds, as regards its structure, functioning and manufacture, to the first embodiment illustrated in FIGS. 1 and 2, so in this respect reference is made to the description thereof above.

1. A device for cleaning a workpiece, including an arrangement for generating a negative pressure as a result of which a cleaning fluid is drawable out of a cavity in the workpiece by suction,
wherein the arrangement for generating the negative pressure includes an injector.

2. A device according to claim 1, wherein the device includes an adapter for making a fluid connection between a discharge opening of a cavity in the workpiece and the injector.

3. A device according to claim 1, wherein the device includes a suction system that includes the injector and at least two adapters for making a fluid connection between, in each case, one discharge opening of a cavity in the workpiece and the injector.

4. A device according to claim 1, wherein the injector includes an injection nozzle for introducing an injection fluid into an interior of the injector.

5. A device according to claim 4, wherein the interior of the injector has a constriction downstream of the injection nozzle.

6. A device according to claim 1, wherein the device includes an outlet closing device downstream of the injector, for the purpose of closing off a flow path of a fluid discharged from the injector.

7. A device according to claim 1, wherein the device includes an injection closing device upstream of the injector, for the purpose of closing off a flow path of an injection fluid to be supplied to the injector.

8. A device according to claim 1, wherein the device includes a modulation device upstream of the injector, for the purpose of generating a modulated injection fluid flow to the injector.

9. A device according to claim 1, wherein the device includes at least two injectors that are configured to be brought into fluid connection with a respective discharge opening of a cavity in the workpiece.

10. A device according to claim 9, wherein the device includes a manipulator by means of which the workpiece and/or at least one injector is movable from a separated position in which the workpiece and the respective injector are separated from one another into a connected position in which a cavity in the workpiece and the respective injector are in fluid connection with one another.

11. A device according to claim 1, wherein the device includes at least one jet nozzle that is configured to generate a jet of a jet fluid that is directed towards an access opening to a cavity in the workpiece.

12. A device according to claim 1, wherein the device includes a cleaning fluid vessel in which the workpiece is configured to be arranged such that an access opening to a cavity in the workpiece is immersed in a volume of cleaning fluid that is in the cleaning vessel.

13. A combination of a device for cleaning a workpiece and a workpiece to be cleaned using the device, the device including an arrangement for generating a negative pressure as a result of which a cleaning fluid is drawable out of a cavity in the workpiece by suction, wherein the arrangement for generating the negative pressure includes an injector.

14. A method for cleaning a workpiece that includes a cavity having an access opening and a discharge opening, including the following:
arranging the workpiece such that the access opening is immersed in a volume of cleaning fluid; and
generating a negative pressure by means of which cleaning fluid is drawn out of the workpiece by suction through the discharge opening of the cavity, using an injector.

15. A method according to claim 14, wherein a direction of flow of the cleaning fluid in the cavity in the workpiece is at least temporarily reversed in at least one region of the cavity.
